(19) United States
(12) Patent Application Publication
(10) Pub. No.: US 2014/0016537 A1
(43) Pub. Date: Jan. 16, 2014

(54) ASSOCIATING TERMINAL USER EQUIPMENT WITH USER EQUIPMENT RELAYS

(71) Applicant: QUALCOMM Incorporated, San Diego, CA (US)

(72) Inventors: Abhijit S. Khobare, San Diego, CA (US); Gavin B. Horn, La Jolla, CA (US); Miguel Griot, La Jolla, CA (US); Aleksandar Damnjanovic, Del Mar, CA (US); Rajat Prakash, San Diego, CA (US)

(21) Appl. No.: 13/886,219

(22) Filed: May 2, 2013

Related U.S. Application Data
(60) Provisional application No. 61/643,065, filed on May 4, 2012.

(51) Int. Cl. H04W 36/30

(52) U.S. Cl. CPC H04W 36/30
USPC 370/315

(57) ABSTRACT

An operational characteristic of a relay is determined. The relay is a user equipment (UE) serving as an eNB. The operational characteristic includes one or more of a quality of a relay backhaul and a capacity of the relay backhaul. The relay backhaul includes a communications link between the relay and an eNB. A determination of whether to perform a handover of a UE is made based on the operational characteristic of the relay and a corresponding operational characteristic of the eNB.

### CROSS-REFERENCE TO RELATED APPLICATION(S)

This application claims the benefit of U.S. Provisional Application Ser. No. 61/643,065, entitled “Associating Terminal User Equipment With User Equipment Relays” and filed on May 4, 2012, which is expressly incorporated by reference herein in its entirety.

### BACKGROUND

1. Field

The present disclosure relates generally to communication systems, and more particularly, to wireless communications devices that operate as user equipment and relays. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, systems and methods are described for managing the association of terminal user equipment (UE) with eNodeBs (eNBs) and relays. The systems and methods facilitate handovers that enhance the operational capacity and performance of a wireless network.

In an aspect of the disclosure, an operational characteristic of a relay is determined. The relay is a user equipment (UE) serving as an eNB. The operational characteristic of the relay may include one or more of a quality of a relay backhaul, such as path loss and backhaul-link geometry, and a capacity of the relay backhaul. The relay backhaul includes a communications link between the relay and an eNB. The operational characteristic of the relay may also include a path loss of an access link between the relay and the terminal UE. A determination of whether to perform a handover of a UE is made based on one or more operational characteristics of the relay and a corresponding operational characteristic of the eNB.

In another aspect of the disclosure, a request to handover a UE is received. The request includes a measurement report. An operational characteristic of the relay is determined. The operational characteristic of the relay includes one or more of a quality of a relay backhaul and a capacity of the relay backhaul. The relay backhaul includes a communications link between the relay and an eNB. One or more operational characteristics of the UE are determined based on the measurement report. The one or more operational characteristics include one or more of a quality of a UE access to the eNB. The handover is accepted when the difference between corresponding operational characteristics of the relay and the eNB exceeds a first threshold value

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating a network in which UEs are configured to provide relay service.

FIG. 8 is a diagram illustrating a UE architected for providing relay service.

FIG. 9 is a diagram illustrating a UE architected for providing relay service.

FIG. 10 is a simplified diagram illustrating a network comprising UEs configured to provide relay service.

FIG. 11A is a flow chart of a method of wireless communication of an eNB.

FIG. 11B is a flow chart of a method of wireless communication of a relay.

FIG. 12 is a conceptual data flow diagram illustrating the data flow between different modules/means/components in an exemplary apparatus.

FIG. 13 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

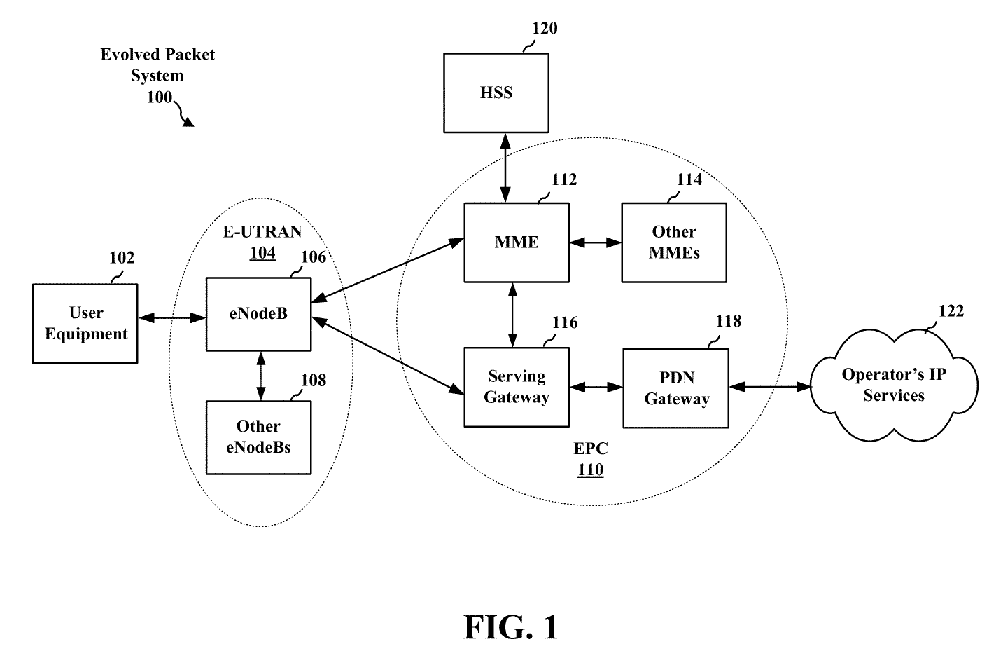

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an 51 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

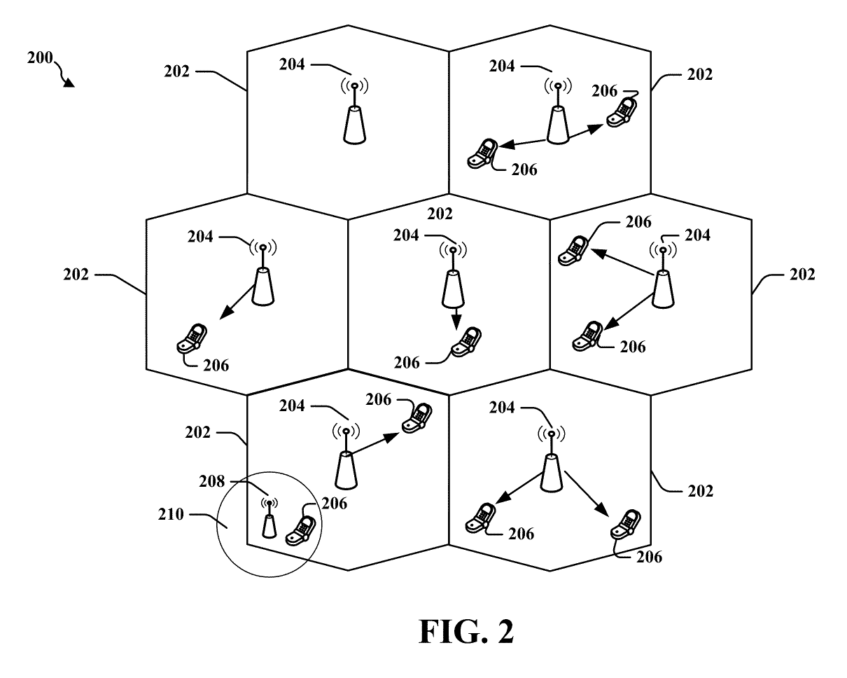

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) to recover the one or more data streams destined for that UE. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

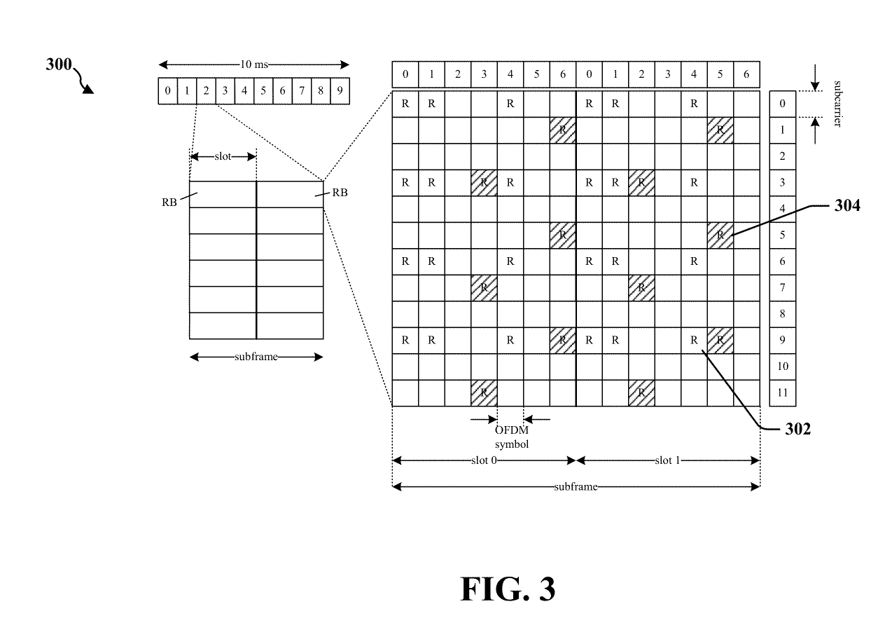

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RSs 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

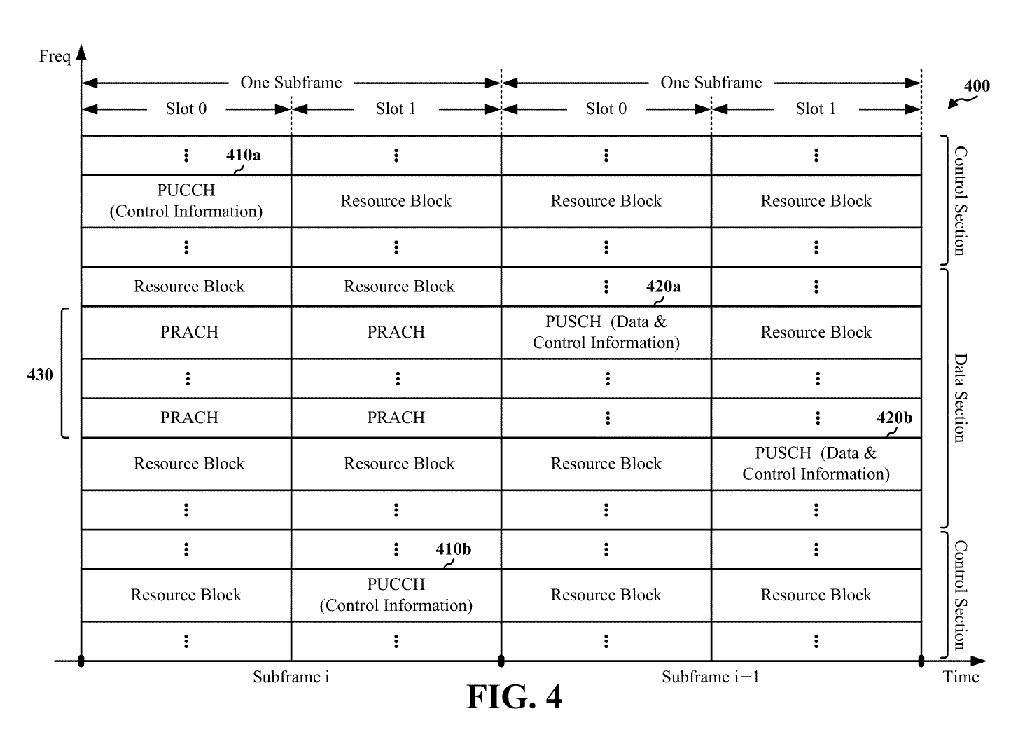

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

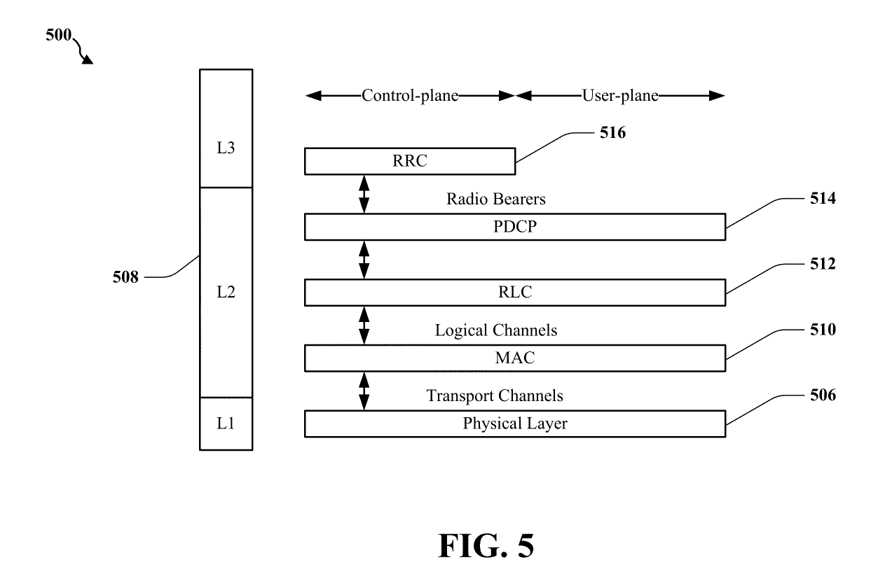

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

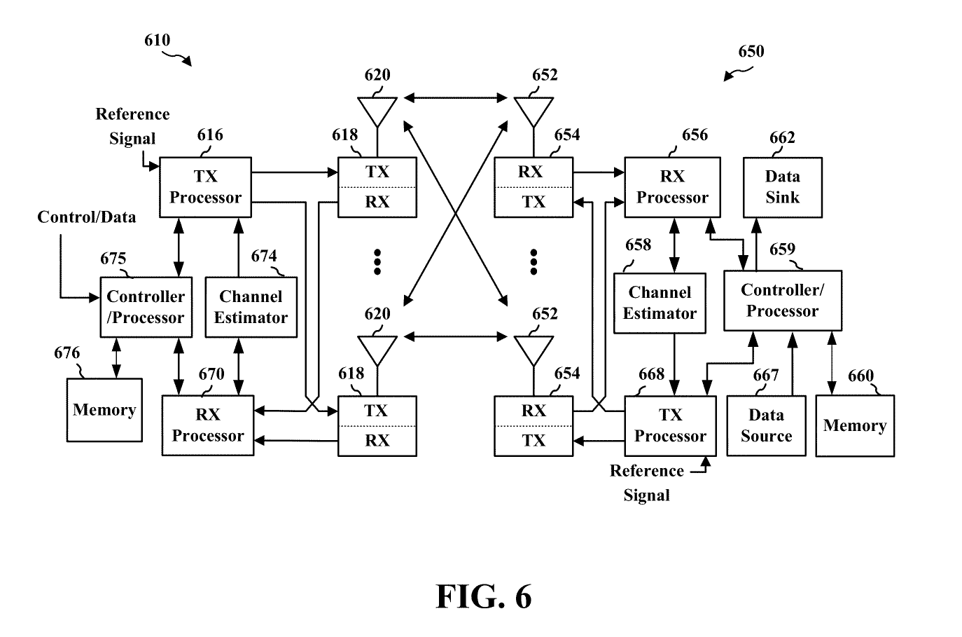

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

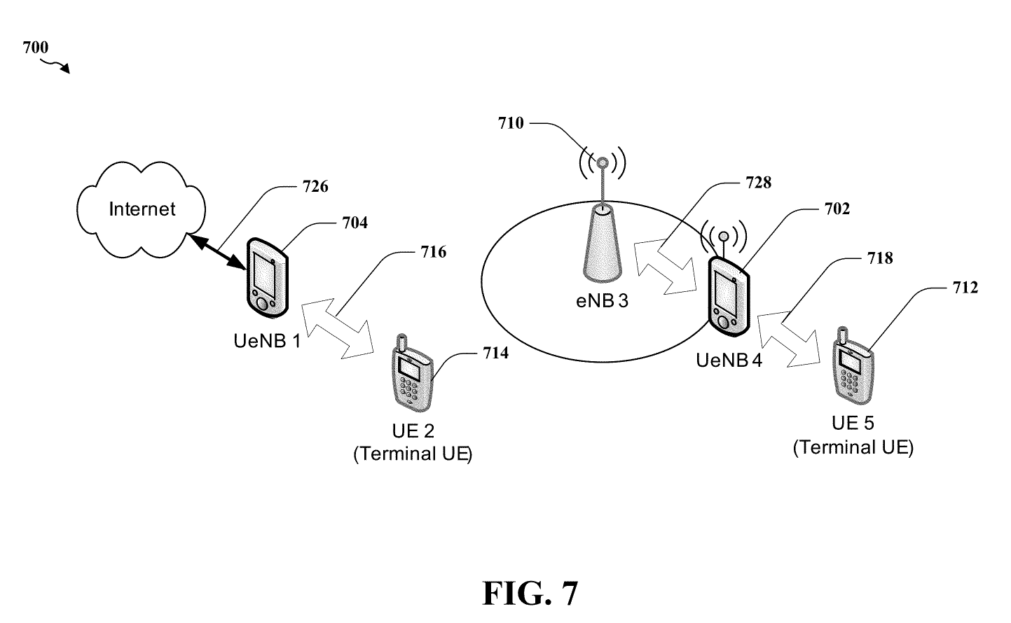

FIG. 7 is a diagram 700 illustrating a network in which a UE serving as an eNodeB (UeNB) 702, 704 provides network connectivity to a terminal UE terminal UE 712, 714. A UeNB 702, 704 may advertise its availability to serve as an eNodeB which provides network connectivity for other UEs 712, 714. In one example, a UeNB 702 has a wireless backhaul 728, which may comprise LTE in a licensed spectrum. The UeNB 702 may provide network services to a terminal UE 712 through a wireless access channel 718. In another example, a UeNB 704 has a wired backhaul 726 and provides network services to a terminal UE 714 through a wireless access channel 716.

On the access-hop 716, 718, both UeNBs 702, 704 may behave essentially like a cell, from the PHY-MAC perspective. The UeNBs 702, 704 may incorporate certain power-saving techniques in addition to those employed by a typical eNB 710 or network-relay (not shown).

In the example of FIG. 7, a UeNB 704 provides a wired backhaul 726 as a wired device, while another UeNB 702 provides a wireless backhaul 728. When functioning as a relay, a UeNB 702 may operate as both an eNB and a UE. The UeNB 702 communicates with a donor eNB 710 on the backhaul 728, behaving essentially like a UE, from a physical/MAC layer (PHY-MAC) perspective. During periods of low traffic activity, the UeNB 702 may go into discontinuous reception (DRX) mode, or idle mode, on the backhaul hop 728 for power-saving, interference reduction, or network-load-alleviation purposes.

A UeNB 702 may provide backhaul over LTE or another RAT, such as GSM, 1x/DO, etc. While the description to follow is from a 3GPP perspective (e.g., RRC connected, RRC idle, etc.) other RATs have their own corresponding mechanisms. The UeNB 702 is typically in connected mode on the backhaul link 728 if it is actively connected to any terminal UEs 712 which is actively transmitting data. The UeNB 702 may be in DRX mode on the backhaul link 728 if all of the connected terminal UEs 712 are also in DRX mode. When the UeNB 702 is released by the network on the backhaul link 728, all the connected terminal UEs 712 are typically released by the UeNB 702.

The UeNB 702 may be in RRC idle or RRC connected mode on the backhaul link 728 to advertise access to terminal UEs 712, 714 when no terminal UEs are connected to the UeNB 702. In some embodiments, the UeNB 702 refrains from using RRC idle mode on the backhaul link 728 in favor of using DRX mode in order to conserve battery power without causing longer overall call setup time for terminal UE 712.

If a UeNB 702 is in RRC idle mode on the backhaul link 728 when a terminal UE 712 attempts to establish a connection, then the UeNB 702 typically establishes a connection on the backhaul link in order to authorize the terminal UE 712 for service. An UeNB 702 typically refrains from advertising service if it is not camped on a suitable cell on the backhaul

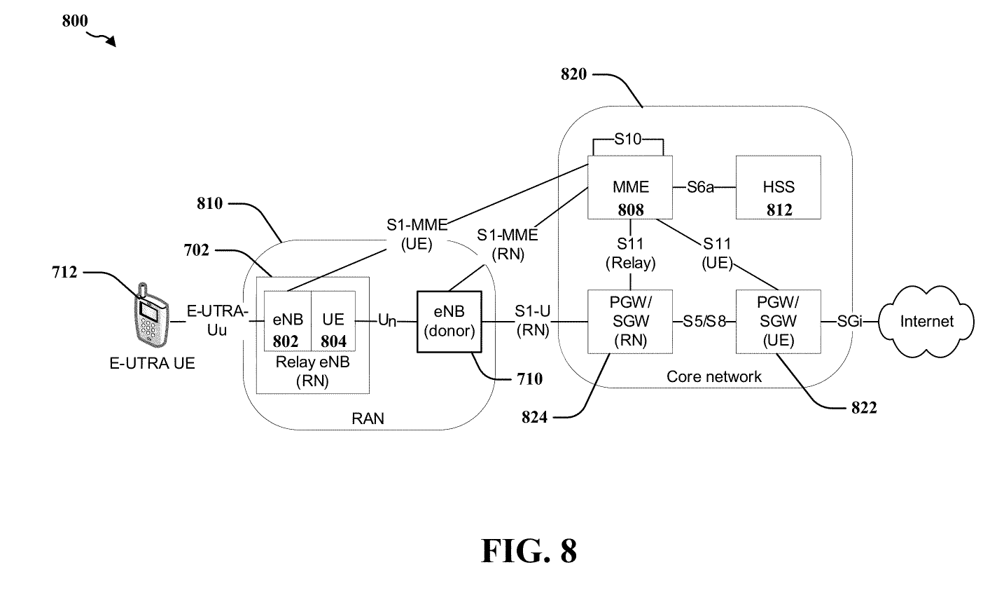

FIG. 8 is a diagram 800 illustrating an example of an architecture used with an UeNB 702. In this example, a UE 712 is served by one or more gateways 824, 822 in the core network 820, such as PDN gateway 822. An UeNB 702 need not have a local PDN gateway. An e-UTRAN 810 comprises an UeNB 702 and an eNB 710. The UeNB 702 may act as a relay for the eNB 710.

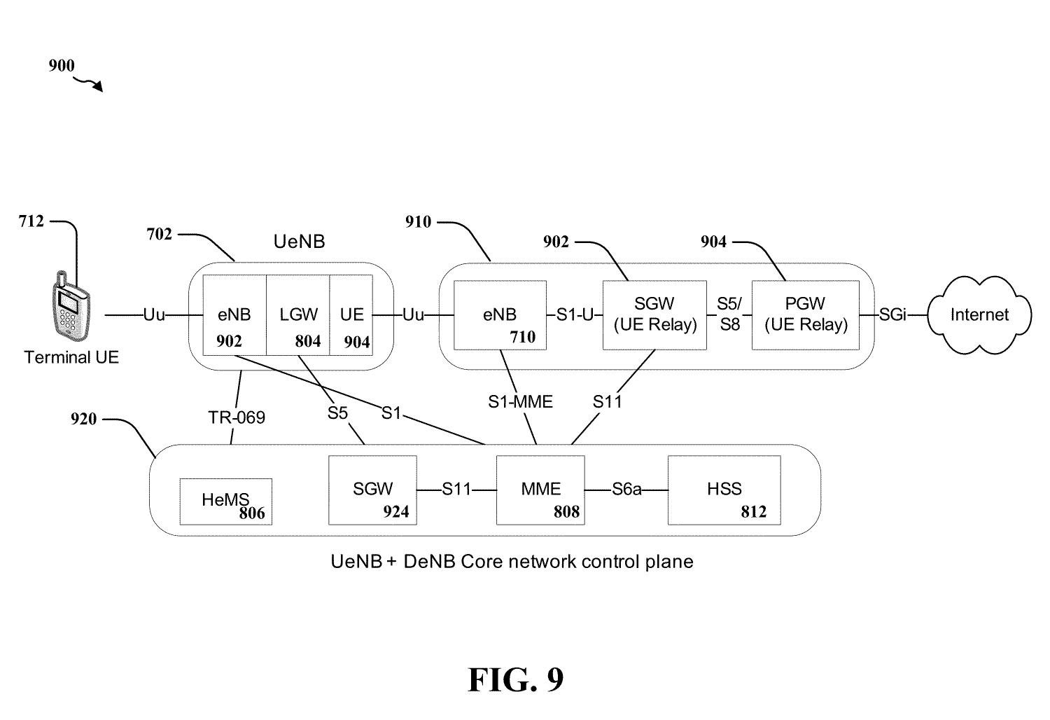

FIG. 9 illustrates an architecture 900 that may be used with an LTE backhaul. An UeNB 702 may be deployed for any type of access connection and any type of backhaul connection and is usable with any of a plurality of networks, including legacy cellular networks, wired networks, Wi-Fi networks, etc.

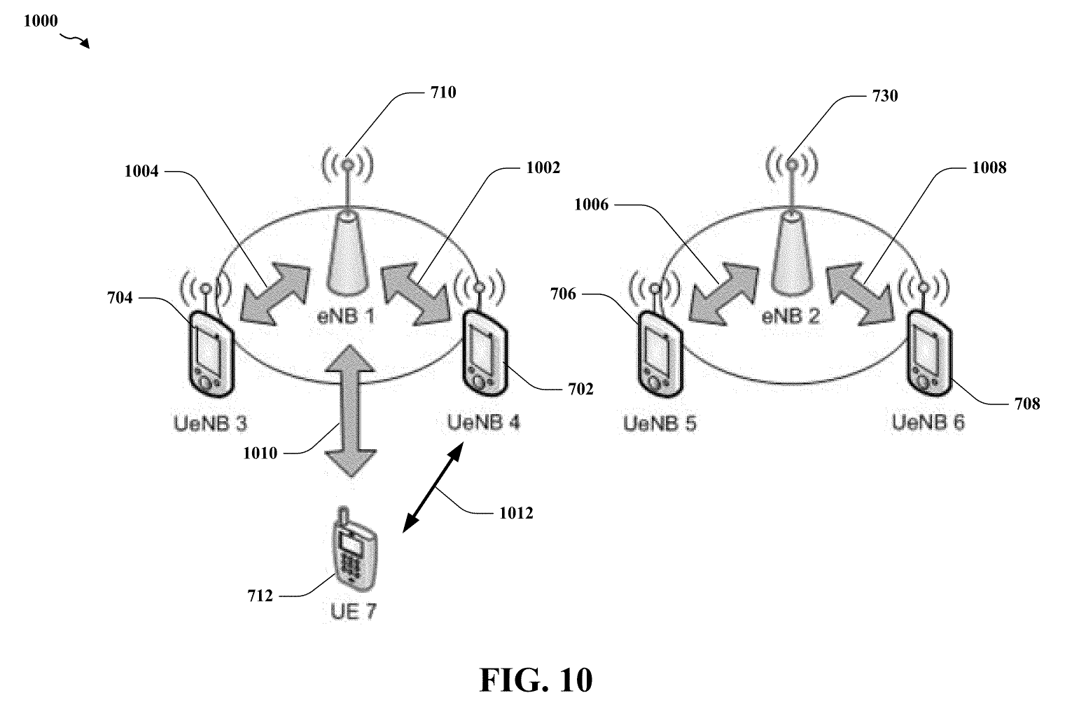

FIG. 10 is a simplified illustration of invention network including UEs configured to provide relay service. System capacity may be improved when a terminal UE 712 associates with an UeNB 702, 704, 706, 708 with sufficient backhaul capacity and quality to increase overall system throughput when the terminal UE 712 is served by UeNB 702, 704, 706, 708 rather than being served through direct access to an eNB 710, 730. The eNB 710 may be referred to herein as a donor eNB when it delegates service of UE 712 to UeNB 702, 704

In some embodiments, a UeNB 702, 704advertises its availability to a terminal UE 712 when the quality measurement of its respective backhaul connection 1002, 1004, i.e., its “backhaul quality” or “backhaul-link quality”, is sufficient. The UeNB 702, 704 may operate only when quality of the backhaul connection 1002, 1004 to the donor eNB 710 exceeds a threshold. Knowledge of the backhaul threshold may be used by a terminal UE 712 while in idle mode for cell reselection and by an eNB 710 or other UeNBs 702, 704 while in connected mode to UE 712 as a basis for making a handover decision.

In some embodiments, system capacity can be improved through optimized association which ensures that a UeNB 702, 704 operates as a relay only when measurements indicate a sufficiently good quality of the UeNB backhaul connection 1002, 1004. When operating as a relay, a UeNB 702, 704 may perform a variety of eNB functions including transmitting PBCH, SIBs, PSS, SSS, common RS, etc.

The UeNB 702, 704 may determine its backhaul quality using one or more of a backhaul-link threshold (BLₜₕᵣₑₛₕ) setting and backhaul-link hysteresis (BL_{hyst}) at the UeNB 702, 704. BLₜₕᵣₑₛₕ and BL_{hyst} may be configured using OAM configuration and/or RRC configuration. In one example, RRC configuration may be advertised in a system information block (SIB) transmitted by donor eNB 710, or sent by unicast to the UeNB 702, 704 when the UeNB is connected to the donor eNB.

The UeNB 702, 704 may monitor its backhaul-link quality BL to determine if a transition in relay status is indicated. For example, if relay functionality is disabled, the UeNB 702, 704 may enable the relay functionality when it determines that BL_{qual}>BLₜₕᵣₑₛₕ+BL_{hyst}. When the relay functionality is enabled, the UeNB 702, 704 may disable relay functionality when it determines that BLqual<BLₜₕᵣₑₛₕ−Bl_{hyst}. In addition to the above criteria for turning on/off relay functionality, the UeNB 702, 704 may use its existing loading conditions, which may be measured as a number of terminal UEs 712 connected to the UeNB 702, 704 to reject new connection from terminal UEs or handover requests from other eNBs. For example, when loading conditions reach a threshold, the UeNB 702, 704 may reject new connections from terminal UEs 712 or handover requests from other eNBs 710.

Backhaul-link thresholds may be maintained by a UE 712 for an UeNB 702, 704. The thresholds maintained on the UE 712 may be predefined by standards and/or network operators. The thresholds maintained on the UE 712 may be dynamically configured by one or more SIBs transmitted by an eNB 710 or by another UeNB 702, 704. A terminal UE 712 may monitor the backhaul-link quality 1002, 1004 of neighboring UeNBs 702, 704, and may associate with a suitable UeNB 702, 704 whose backhaul-link geometry is better than the access-link geometry 1010 between the UE 712 and eNB 710.

A donor eNB 710 may be informed of a backhaul-link threshold for a UeNB 702, 704 through a configurable or predefined threshold specified by network standards and/or network operators. An eNB 710 may determine that a handover of a terminal UE 712 to a UeNB 702 is to be performed based on measurement reports provided by the terminal UE 712. The eNB 710 may initiate a handover when the path loss of access-link 1012 between the terminal UE 712 and UeNB 702 is less than a second threshold value, and the backhaul-link geometry 1002 of the UeNB 702 exceeds the access-link geometry 1010 of the terminal UE 712 to the eNB 710.

In some embodiments, a UeNB 702, 704 signals available capacity based on current loading and backhaul 1002, 1004 capacity. Knowledge of the backhaul capacity and its relationship to one or more thresholds may be used by the terminal UE 712 while in idle mode for cell reselection, and by an eNB 710 or another UeNB 702, 704 when the terminal UE 712 is in connected mode to determine whether a handover should be initiated.

The available capacity at an UeNB 702, 704 may be determined based on 1) measurements and/or analysis of backhaul-link 1002, 1004 quality statistics for the UeNB 702, 704, 2) the number of UEs 712 that are currently connected to the UeNB 702, 704, and their service requirements, and/or 3) jitter in cell-specific signal strength metrics such as reference signal received power (RSRP) (or similar signals such as received signal code power) received from UeNB 702, 704 and measured by the terminal UE 712.

In some embodiments, an UeNB 702, 704 advertises available capacity in a SIB. A donor eNB 710 typically knows both the backhaul link 1002. 1004 quality and the loading of the UeNBs 702, 704 served by the donor eNB 710.

In some embodiments, a terminal UE 712 monitors the available capacity advertised by neighboring UeNBs 702, 704 and may associate with a suitable UeNB 702, 704 that has available capacity to serve the current QoS requirements of the UE 712. The terminal UE 712 may associate with a suitable UeNB 702, 704 that offers a better link geometry to the UE 712 than the link geometry 1010 of the UE 712 to the eNB 710. Terminal UE 712 may also use jitter in RSRP measurements to filter out one or more UeNBs 702, 704 from being considered for association. Available capacity may be used as a metric to maximize offload of data to UeNBs 702, 704 while backhaul link 1002, 1004 quality may be signaled to enable a clearer determination of whether the association of the terminal UE 712 with the UeNB 702, 704 would increase system capacity. Available capacity at the UeNB 702, 704 may be used to determine the loading at the UeNB 702, 704, i.e., whether there is enough capacity to actually serve the terminal UE 712. Thus, some embodiments signal backhaul quality and available capacity separately. Backhaul threshold is used in some embodiments as an additional criterion for UeNB 702, 704 activation.

In certain embodiments, measurement reports by the terminal UE 712, including reports by the UE 712 of available capacity, may be used by a donor eNB 710 to determine whether a terminal UE 712 may be handed over to an UeNB 702, 704. Such measurement reports may be based on the available capacity for a UeNB 702, 704 as advertised by that UeNB in a SIB reported to the eNB 710. The determination may be based on whether the access-link 1012 path loss between the terminal UE 712 and the UeNB 702, 704 is less than a threshold value, and whether the backhaul-link geometry signaled in the available capacity of the UeNB 702, 704 is greater than the access-link geometry 1010 of the terminal UE 712 to the eNB 710.

In certain embodiments, a donor eNB 710 may use local backhaul knowledge of served UeNBs 702, 704 in determining the efficacy of handover. A donor eNB 710 serving a UeNB 702, 704 may use the measurement reports of the served UeNB to infer local available capacity of the UeNB and to determine whether to initiate a handover of the UE 712 in connected mode to the UeNB. Association procedures when the donor eNB 710 uses local backhaul knowledge of served UeNBs 702, 704 may rely on the premise that the donor eNB 710 associated with the terminal UE 712 can obtain sufficient information to initiate a handover of the terminal UE 712 to a selected UeNB.

In some embodiments, the donor eNB 710 may base a handover decision on information that includes one or more of backhaul-link, the number of terminal UEs 712 connected to a UeNB 702, 704, the service requirements of terminal UEs 712 connected to the UeNB, and access-link 1012 path loss measurements of the UeNB reported by the terminal UE 712.

In some embodiments, the backhaul link 1002, 1004 quality of an UeNB 702, 704 may be associated with the access link 1012 measurement reported by a terminal UE 712 of the UeNB 702, 704 based on information provided by the UE 712. The information may include a cell global identity (CGI) of detected UeNBs 702, 704 in a measurement report. In one example, the CGI may be obtained using an automatic neighbor relation (ANR) function or proximity indication procedure used for femtocell in-bound mobility. The information provided by UE 712 may also include a report of mapping of the CGI for a UeNB 702, 704 CGI reported by the terminal UE 712 and the international mobile subscriber identity (IMSI) corresponding to the UE portion 804 (see FIG. 8) of the UeNB 702, 704, 706, 708. In some embodiments, a donor eNB 710 need only know the mapping of the physical cell identifier (PCI) reported by the terminal UE 712, to the IMSI corresponding to the UE 804 part of the UeNB 702, 704.

The donor eNB 710 may map the PCl/CGI reported by the terminal UE 712 to a served UeNB 702, 704 using one or more of RRC signaling, non-access stratum (NAS) signaling, and operation and maintenance (OAM) signaling where the eNB 710 queries OAM for the latest information regarding UeNB 702, 704, based on one or more of UE 712 reported CGI, and OAM pushed information of UeNBs 702, 704 in the region to the eNB 710.

In some embodiments, RRC signaling may be used to map PCl/CGI reported by a terminal UE 712 to a served UeNB 702, 704. When the UeNB 702, 704 is authorized to start performing as a relay, the donor eNB 710 may send an RRC UeNB information request message to the UE 712 to obtain the PCl/CGI of the UeNB 702, 704. It will be appreciated that the CGI of the UeNB 702, 704 is independent of the CGI of the donor eNB 710. The UeNB 702, 704 may respond with the PCl/CGI it is advertising in its function as a relay. The eNB 710 may now have sufficient information to map the PCl/CGI of the UeNB 702, 704 to its UE 804 identity (IMSI, S-TMSI etc.)

In some embodiments, NAS signaling mechanisms may be used to map PCI/CGI reported by UE 712 to a served UeNB 702, 704. During, or related to an UeNB 702, 704 authorization using NAS, the UeNB 702, 704 may pass the information, including PCl/CGI, to MME 808. The information may also, or alternatively, be passed to MME 808 as part of a service request. The UeNB 702, 704 connects to the eNB 710 using a service request or tracking area update (TAU) request. The MME 808 may forward UeNB information to the eNB 710, typically as part of UE Context Setup. During handover, the UeNB information may be included by the MME 808 in a path switch accept message or as part of the context transfer from the source eNB through an interface used to interconnect eNBs (e.g. X2).

In certain embodiments, donor eNB 710 uses full backhaul knowledge of neighboring UeNBs 702, 704. The donor eNB 710 may use the measurement reports of the UeNB 702, 704 and X2 messaging to infer the available capacity of a UeNB and to determine whether to hand over a terminal UE 712 in connected mode to a UeNB.

In certain embodiments, an UeNB 702, 704 may accept or reject the handover request based on measurement report provided by the terminal UE 712. The donor eNB 710 may forward the measurement reports of the UE 710 as part of the handover request and the UeNB 702, 704 may determine whether to accept or reject the handover based on the relative path loss of the terminal UE 712 to the donor eNB 710 and the terminal UE to the UeNB. The UeNB 702, 704 may also consider current loading and backhaul capacity. The donor eNB 710 forwards the measurement reports of the terminal UE 712 in the handover request and the UeNB 702, 704 decides whether to accept or reject the handover based on the relative path loss of the UE to the donor eNB and the UeNB as well as the current loading and backhaul capacity.

In certain embodiments, the donor eNB 710 forwards measurement reports of the terminal UE 712 to the UeNB 702 in the handover request. The UeNB 702 may also consider a backhaul threshold to determine whether it should operate as a relay in order to avoid unnecessary handover requests. When the UeNB 702 receives the handover request from the donor eNB 710, it may use various criteria to determine whether to accept or reject the handover. The criteria may include backhaul-link 1002 information, number of currently connected terminal UEs 712, and service requirements of terminal UEs 712 currently connected to the UeNB 702. The criteria may include access-link 1010, 1012 path loss measurements to the UeNB 702 and the donor eNB 710 as reported by the terminal UE 712 and included in the handover request.

The UeNB 702 may determine that the handover request can be accepted when the access-link 1012 path loss between the terminal UE 712 and the UeNB 702 is greater than a threshold value, and/or the backhaul-link 1002 geometry of the UeNB 702 is greater than the access-link 1010 geometry of the terminal UE to the eNB.

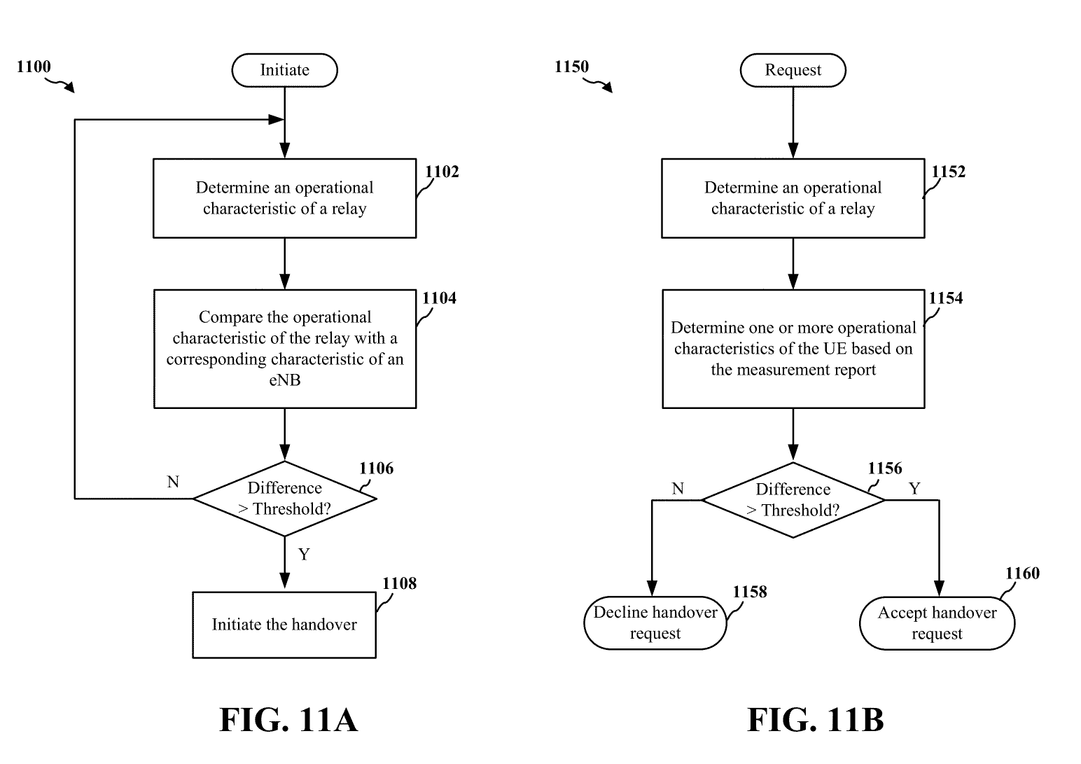

FIG. 11A includes a flow chart 1100 of a method of wireless communication. The method may be performed by an eNB 710. At step 1102, the eNB 710 determines an operational characteristic of a relay 702 (FIG. 10). The relay 702 may be an UE serving as an eNodeB, i.e., a UeNB. The UeNB is configurable to function as a relay. The operational characteristic of the relay may include one or more of a quality of a relay backhaul and a capacity of the relay backhaul 1002. The relay backhaul is a communications link between the eNB 710 and the relay 702. Determining the operational characteristic of the relay 702 may include determining whether the quality of the relay backhaul 1002 exceeds a predefined threshold quality. The operational characteristic of the relay 702 may include a capacity of a wireless access channel 1012 between the relay 702 and the UE 712.

Determining an operational characteristic of the relay 702 may include receiving the operational characteristic of the relay in a message. The message may be in any of several forms. For example, the message may be a message received over an X2 interface from a different eNodeB 1030 serving the relay 702. In this case, the operational characteristic is the quality of the relay backhaul 1002 and the eNB 710 determines the quality based on the message. As another example, the message may be a measurement report provided to the eNB 710 by the UE 712. The operational characteristic of the relay 702 may be provided by the relay to the UE 712 in a system information block. In this case, the measurement report may identify signal strength measured by the UE 712 of one or more of a signal sent by the relay 702, and a signal sent by the eNB 710. The quality of the wireless access channel 1012 may comprise one or more of a path loss between the relay 702 and the UE 712, and a backhaul-link geometry between the UE 712 and the relay 702.

The operational characteristic may comprise backhaul-link quality measurements for the relay 702. The message may comprise a measurement report received from one or more of the relay and an eNB 710. The quality of the relay backhaul 1002 may be determined based on the measurement report. The relay 702 and UE 712 may provide measurement reports. The relay 702 and eNB 710 may communicate through an X2 interface.

At step 1104, the eNB 710 may compare the operational characteristic of the relay 702 with a corresponding characteristic of another eNB 710 or another relay 704, 706 or 708.

At step 1106, the eNB 710 may compare the difference between the operational characteristic of the relay 702 and the corresponding characteristic of the other eNB 730. The comparison may be performed to determine whether to perform a handover. The determination may include comparing a difference between the operational characteristic of the relay 702 and the corresponding operational characteristic of the eNB 710 to a threshold. If the difference exceeds a threshold, the eNB 710 may initiate the handover at step 1108. The operational characteristic of the relay 702 may be provided in a system information block. The operational characteristic of the relay 702 may be received in a message. The message may comprise a measurement report sent by the UE 712. The measurement report may identify a signal strength measured by the UE 712. The signal strength may relate to one or more of a signal sent by the relay 702, and a signal sent by the eNB 710. The message may comprise a measurement report received from the relay 702. The quality of the relay backhaul 1002 may be determined based on a backhaul-link quality measurement provided in the measurement report. The message may comprise a message received over an X2 interface from a different eNB 730 serving the relay 702. The quality of the relay backhaul 1002 may be determined based on the message.

The eNB 710 may initiate the handover at step 1108 when the difference between a backhaul-link 1002 geometry of the relay 702 and an access-link 1010 geometry between the UE 712 and the eNB 710 exceeds a threshold. The eNB 710 may initiate the handover at step 1108 when the quality of the wireless access channel 1012 between the relay 702 and the UE 712 exceeds a threshold. The quality of the wireless access channel 1012 may be based on one or more of a path loss between the relay 702 and the UE 712, and backhaul link 1002 geometry between the eNB 710 and the relay 702.

In some embodiments, the handover may be initiated by an eNB 710 based upon a determination of available capacity of the relay 702 inferred from X2 messages. The relay 702 may reject a handover of the UE 712 based on available capacity of the relay.

FIG. 11B includes a flow chart 1150 of a method of wireless communication. The method may be performed by a relay 702. The method may be initiated when the relay 702 receives a request to handover a UE 712. The request may include a measurement report.

At step 1152, the relay 702 determines an operational characteristic of the relay. The operational characteristic of the relay 702 may comprise one or more of a quality of a backhaul 1002 of the relay 702 and a capacity of the relay backhaul 1002.

At step 1154, the relay 702 may determine one or more operational characteristics of the UE 712 based on the measurement report. The operational characteristics may comprise one or more of a quality of an access link 1010 between the UE 712 and an eNB 710.

At step 1156, the relay 702 may compare the difference between corresponding operational characteristics of the relay and the eNB 710 to determine if the difference exceeds a first threshold value.

At step 1158, the relay 702 may decline the request for handover if the threshold is determined to be not exceeded at step 1156. The request may be declined, for example, when the difference between corresponding operational characteristics of the eNB 710 and the relay 702 is less than a threshold value.

At step 1160, the relay 702 may accept the request for handover if the threshold is determined to be exceeded at step 1156. The request may be accepted, for example, when the difference between corresponding operational characteristics of the relay 702 and the eNB 710 exceeds a first threshold value.

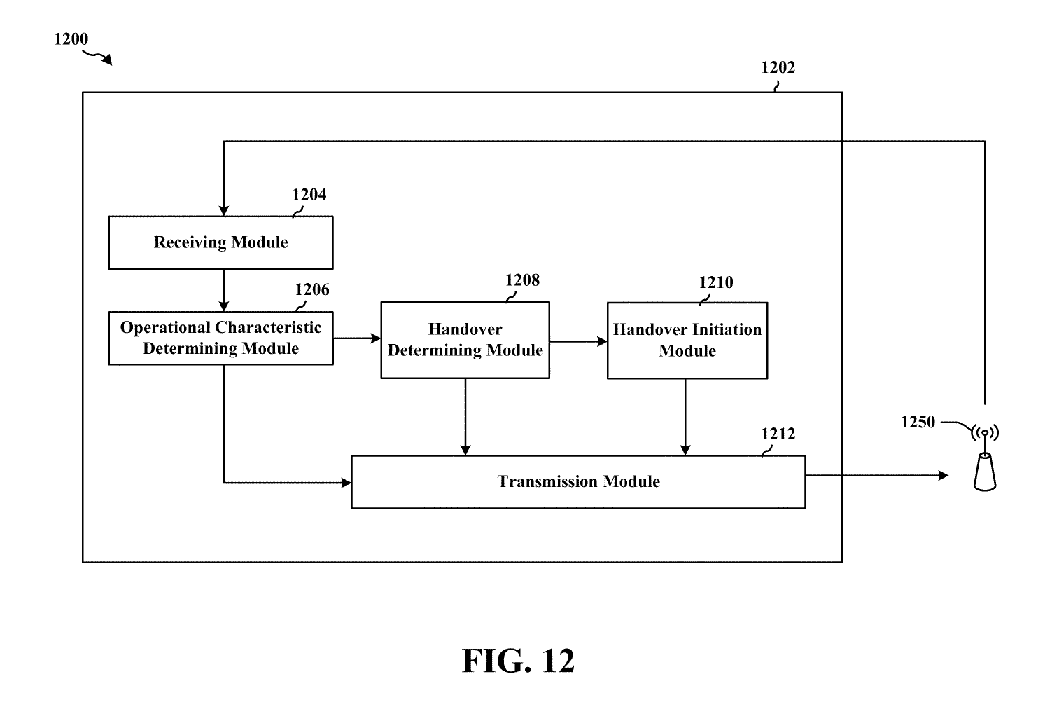

FIG. 12 is a conceptual data flow diagram 1200 illustrating the data flow between different modules/means/components in an exemplary apparatus 1202. The apparatus may be an eNB 710 or a UeNB 702. The apparatus 1202 includes a receiving module 1204 that receives signals from a wireless network, an operational characteristic determining module 1206 that determines operational characteristics of the eNB 710, the UeNB 702 and/or a UE 712 from the received signals. The apparatus 1202 also includes a handover determining module 1208 that determines whether to perform a handover based on the operational characteristics, a handover initiation module 1210 that selectively performs or initiates a handover responsive to decisions of module 1210, and a transmission module 1212 that transmits signals over the wireless network.

The apparatus 1202 may include additional modules that perform each of the steps of the algorithm in the aforementioned flow charts of FIGS. 11A and 11B. As such, each step in the aforementioned flow charts of FIGS. 11A and 11B may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

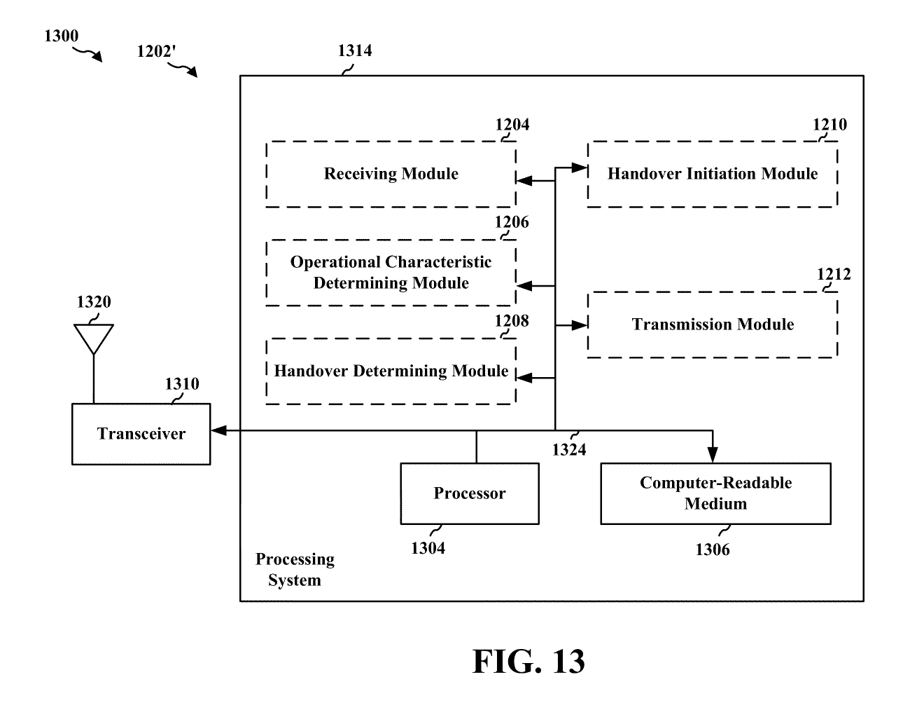

FIG. 13 is a diagram 1300 illustrating an example of a hardware implementation for an apparatus 1202′ employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware modules, represented by the processor 1304, the modules 1204, 1206, 1208, 1210, 1212 and the computer-readable medium 1306. The bus 1324 may also link various other circuits such as timing sources, peripherals, voltage regulators, and power management circuits, which are well known in the art, and therefore, will not be described any further.

The processing system 1314 may be coupled to a transceiver 1310. The transceiver 1310 is coupled to one or more antennas 1320. The transceiver 1310 provides a means for communicating with various other apparatus over a transmission medium. The processing system 1314 includes a processor 1304 coupled to a computer-readable medium 1306. The processor 1304 is responsible for general processing, including the execution of software stored on the computer-readable medium 1306. The software, when executed by the processor 1304, causes the processing system 1314 to perform the various functions described supra for any particular apparatus. The computer-readable medium 1306 may also be used for storing data that is manipulated by the processor 1304 when executing software. The processing system further includes at least one of the modules 1204, 1206, 1208, 1210, and 1212. The modules may be software modules running in the processor 1304, resident/stored in the computer readable medium 1306, one or more hardware modules coupled to the processor 1304, or some combination thereof. The processing system 1314 may be a component of the eNB 610 and may include the memory 676 and/or at least one of the TX processor 616, the RX processor 670, and the controller/processor 675.

In one configuration, the apparatus 1202/1202′ for wireless communication includes one or more of means 1206 for determining an operational characteristic of a relay 702, means 1208 for determining whether to perform a handover of a UE 712 based on the operational characteristic of the relay 702 and a corresponding operational characteristic of an eNB 710 or a second relay 704, means 1210 for accepting and/or initiating the handover when the difference between corresponding operational characteristics of the relay and the eNodeB exceeds a first threshold value, means 1204 for receiving a request to handover UE 712 that includes a measurement report, wherein means 1206 may also determine one or more operational characteristics of the UE based on the measurement report.

The operational characteristics may comprise one or more of a quality of a UE access to an eNB 710. The operational characteristic may comprise one or more of a quality of a backhaul 1002 of the relay 702 and a capacity of the relay backhaul 1002. The handover may be rejected when the difference between corresponding operational characteristics of the eNB 710 and the relay 702 is less than a second threshold value.

Determining the operational characteristic of the relay 702 may include determining whether the quality of the relay backhaul 1002 exceeds a predefined threshold quality. Determining an operational characteristic of the relay 702 may include receiving the operational characteristic of the relay in a message. The message may comprise a measurement report provided by the UE 712. The measurement report and operational characteristic of the relay 702 may be provided in a system information block. The measurement report may identify one or more of a path loss between the relay and the UE 712, a backhaul-link geometry between the UE 712 and the eNB 710, a backhaul-link geometry between the UE 712 and the relay, and a number of UEs 712 served by the relay.

The operational characteristic may comprise backhaul-link quality measurements for a plurality of relays. The message may comprise a measurement report received from one or more of the relay and an eNB 710. The quality of the relay backhaul 1002 may be determined based on the measurement report. The one or more relay and eNB 710 may communicate the measurement report in a radio resource control (RRC) signaling. The one or more relay and eNB 710 may communicate through an X2 interface. The measurement report may be obtained from the UE 712.

Means 1206 may compare the difference between the operational characteristic of the relay 702 and the corresponding characteristic of the eNB 710. The comparison may be performed to determine whether to perform a handover. The determination may includes comparing a difference between the operational characteristic of the relay 702 and the corresponding operational characteristic of the eNB 710 or the second relay 704, 706, 708 to a threshold.

If the difference exceeds a threshold, means 1210 may initiate the handover. The handover may be initiated when the capacity of the relay backhaul 1002 exceeds the capacity of the eNB backhaul by a first threshold value and when the eNB 710 currently serves the UE 712. The handover may be initiated when the capacity of the eNB backhaul exceeds the capacity of the relay backhaul 1002 by a second threshold value, when the relay 702 currently serves the UE 712, and when the difference between the first and second threshold values provides a desired hysteresis. The handover may be initiated when the capacity of the relay backhaul 1002 exceeds the capacity of the second relay backhaul by a first threshold value, and when the second relay currently serves the UE 712. The handover may be initiated when the quality of the relay backhaul 1002 exceeds the quality of the eNB 710 backhaul by a first threshold value, and when the eNB currently serves the UE 712. The handover may be initiated when the quality of the eNB backhaul exceeds the quality of the relay backhaul 1002 by a second threshold value, when the relay 702 currently serves the UE 712, and when the difference between the first and second threshold values provides a desired hysteresis.

In some embodiments, the handover may be initiated based upon a determination of available capacity of the relay 702 inferred from X2 messages. The relay 702 may reject a handover of the UE 712 based on available capacity of the relay.

The aforementioned means may be one or more of the aforementioned modules of the apparatus 1202 and/or the processing system 1314 of the apparatus 1202′ configured to perform the functions recited by the aforementioned means. As described supra, the processing system 1314 may include the TX Processor 616, the RX Processor 670, and the controller/processor 675. As such, in one configuration, the aforementioned means may be the TX Processor 616, the RX Processor 670, and the controller/processor 675 configured to perform the functions recited by the aforementioned means.

Thus disclosed herein are various mechanisms for associating terminal UEs with UeNBs. In summary, under a first association mechanism (1), a UeNB uses a backhaul threshold. The UeNB operates when quality of the backhaul connection to the donor eNB exceeds a threshold. The knowledge of the backhaul threshold may be used by UEs in idle mode for cell (re)selection; and eNBs or other UeNBs in connected mode to make a handover decision.

Under a second association mechanism (2), a UeNB signals available capacity. The UeNB advertises its current available capacity based on its current loading and backhaul capacity. The knowledge of the backhaul threshold may be used by UEs in idle mode for cell (re)selection; and eNBs or other UeNBs in connected mode (if reported to the (U)eNB) to make the handover decision.

Under a third association mechanism (3), a donor eNB uses local backhaul knowledge of served UeNBs. The donor eNB serving the UeNB uses the measurement reports of the UeNB to infer the local available capacity of the UeNB and determine whether to handover the UE in connected mode to the UeNB.

Under a fourth association mechanism (4), a donor eNB uses full backhaul knowledge of neighboring UeNBs. The donor eNB uses the measurement reports of the UeNB and X2 messaging to infer the available capacity on a UeNB and determine whether to handover the UE in connected mode to the UeNB.

Under a fifth association mechanism (5), a UeNB accepts/rejects the HO request based on the UE's measurement report. The donor eNB forwards the measurement reports of the UE in the handover request and the UeNB decides whether to accept or reject the handover based on the relative path loss of the UE to the donor eNB and the UeNB as well as the current loading and backhaul capacity.

The above association mechanism may be used either singularly or in combination with one another. The following table provides various use cases.

| Association | | |
|---|---|---|
| Mechanisms | Idle mode usage | Connected mode usage |
| (1) only | UE uses the knowledge | UeNB uses the knowledge |
| UeNB uses a | of the threshold to | of the threshold to |
| backhaul | determine whether to | determine whether to HO |
| threshold | camp on the UeNB based | the UE to the UeNB* |
| | on its current service | |
| | requirements | |
| (2) only | UE uses the signaled | UE reports the available |
| UeNB signals | available capacity to | capacity to the UeNB |
| available | determine whether to | which uses it to determine |
| capacity | camp on the UeNB based | whether to HO the UE to |
| | on its current service | the UeNB based on the |
| | requirements | UEs current service |
| | | requirements* |
| (3) + (1)/(2) | Use (1) or (2) if available | For served UeNBs, the |
| Donor eNB uses | | donor eNB uses the |
| local backhaul | | measurement reports of the |
| knowledge of | | UeNB to infer the local |
| served UeNBs; | | available capacity of the |
| (1) or (2) is also | | UeNB to determine |
| available for | | whether to HO the UE* |
| UEs in idle | | For non-served UeNBs, the |
| mode and for | | donor eNB uses (1) or (2) if |
| HO to non- | | available to determine |
| served UeNBs | | whether to HO the UE* |
| (4) + (1)/(2) | Use (1) or (2) if available | For served UeNBs, the |
| Donor eNB uses | | donor eNB uses the |
| full backhaul | | measurement reports of the |
| knowledge of | | UeNB to infer the local |
| neighboring | | available capacity of the |
| UeNBs | | UeNB to determine |
| (1) or (2) is also | | whether to HO the UE* |
| available for | | For non-served UeNBs, the |
| UEs in idle | | donor eNB uses the reports |
| mode and for | | of the UeNB sent over X2 |
| HO to UeNBs | | by the neighboring (U)eNB |
| with no X2 | | to determine whether to HO |
| | | the UE to the UeNB* |
| (5) + (1) | Use (1) if available | The donor eNB includes |
| UeNB | | the measurement reports of |
| accepts/rejects | | the UE in the HO request to |
| the HO request | | the UeNB and the UeNB |
| based on the | | determines whether to |
| UE's | | accept/reject the UE based |
| measurement | | on whether it will increase |
| report | | overall system capacity |
| (1) is also | | |
| available for | | |
| UEs in idle | | |
| mode | | |

The following table describes association parameters used at the various system nodes for each of the five association mechanisms described above.

| Association | | | |
|---|---|---|---|
| Mechanism | Terminal UE | Donor eNB | UeNB |
| (1) | UeNB backhaul | N/A | UeNB backhaul |
| | threshold read | | threshold read from |
| | from OAM | | OAM, |
| (2) | UeNB backhaul | N/A | UeNB backhaul |
| | threshold read | | threshold read from |
| | from OAM, | | OAM |
| | UeNB-advertised | | |
| | backhaul capacity | | |
| | and quality | | |
| | indicators for all | | |
| | UeNBs in UE's | | |
| | search list | | |
| (3) | N/A | Backhaul capacity | N/A |
| | | and quality | |
| | | indicators for all | |
| | | UeNBs connected | |
| | | to the Donor eNB | |
| (4) | N/A | Backhaul capacity | N/A |
| | | and quality | |
| | | indicators for all | |
| | | UeNBs connected | |
| | | to the Donor eNB | |
| | | and all UeNBs | |
| | | connected to | |
| | | neighboring | |
| | | Donor eNBs | |
| (5) | N/A | N/A | UeNB receives |
| | | | measurement report |
| | | | sent by the terminal |
| | | | UE (terminal UE's |
| | | | perceived signal |
| | | | quality of Donor |
| | | | eNB and UeNB) |

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication of an eNodeB (eNB), comprising:
determining an operational characteristic of a relay, the relay being a user equipment (UE) serving as an eNB, the operational characteristic comprising one or more of a quality of a relay backhaul and a capacity of the relay backhaul, the relay backhaul comprising a communications link between the relay and the eNB; and
determining whether to perform a handover of a UE based on the operational characteristic of the relay and a corresponding operational characteristic of the eNB.

2. The method of claim 1, wherein determining whether to perform the handover includes comparing a difference between the operational characteristic of the relay and the corresponding operational characteristic of the eNB to a threshold.

3. The method of claim 2, wherein the operational characteristic of the relay comprises a capacity of a wireless access channel of the relay.

4. The method of claim 2, further comprising initiating the handover when a difference between a backhaul-link geometry of the relay and an access-link geometry between the UE and the eNB exceeds a threshold.

5. The method of claim 1, wherein the relay backhaul comprises a wireless channel and the operational characteristic of the relay comprises a quality of the relay backhaul, and further comprising initiating the handover when the quality of the relay backhaul exceeds a threshold.

6. The method of claim 5, wherein the quality of the relay backhaul comprises one or more of a path loss between the relay and a serving eNB, and a backhaul-link geometry for the relay.

7. The method of claim 1, wherein the operational characteristic of the relay is determined from a message received by the eNB.

8. The method of claim 7, wherein the message comprises a measurement report sent by the UE, and the measurement report identifies signal strength measured by the UE of a signal sent by the relay.

9. The method of claim 7, wherein the message comprises a system information block (SIB) sent by the relay, the SIB including the capacity of the relay.

10. The method of claim 7, wherein the message comprises a measurement report sent by the relay, and wherein the quality of the relay backhaul is determined based on a backhaul-link quality measurement provided in the measurement report.

11. The method of claim 7, wherein the message comprises a message received over an X2 interface from a different eNB serving the relay, and wherein the quality of the relay backhaul is determined based on the message.

12. The method of claim 1, wherein the handover is initiated by an eNB based on a determination of available capacity of the relay inferred from X2 messages.

13. The method of claim 1, wherein the relay rejects a handover of the UE based on available capacity of the relay.

14. An apparatus for wireless communication, comprising:
means for determining an operational characteristic of a relay, the relay being a user equipment (UE) serving as an eNB, the operational characteristic comprising one or more of a quality of a relay backhaul and a capacity of the relay backhaul, the relay backhaul comprising a communications link between the relay and an eNB
means for determining whether to perform a handover of a UE based on the operational characteristic of the relay and a corresponding operational characteristic of the eNB.

15. The apparatus of claim 14, wherein the means for determining whether to perform the handover is configured to compare a difference between the operational characteristic of the relay and the corresponding operational characteristic of the eNB to a threshold.

16. The apparatus of claim 15, wherein the operational characteristic of the relay comprises a capacity of a wireless access channel of the relay.

17. The apparatus of claim 15, further comprising means for initiating the handover when the difference between a backhaul-link geometry of the relay and an access-link geometry between the UE and the eNB exceeds a threshold.

18. The apparatus of claim 14, further comprising means for initiating the handover when the difference between a backhaul-link geometry of the relay and an access-link geometry between the UE and the eNB exceeds a threshold.

19. The apparatus of claim 14, wherein the relay backhaul comprises a wireless channel and the operational characteristic of the relay comprises a quality of the relay backhaul, and further comprising means for initiating the handover when the quality of the relay backhaul exceeds a threshold.

20. The apparatus of claim 19, wherein the quality of the relay backhaul comprises one or more of a path loss between the relay and the UE, and a backhaul-link geometry between the UE and the relay.

21. The apparatus of claim 14, wherein the operational characteristic of the relay is determined from a message received by the eNB.

22. The apparatus of claim 21, wherein the message comprises a measurement report sent by the UE, and the measurement report identifies signal strength measured by the UE of a signal sent by the relay.

23. The apparatus of claim 21, wherein the message comprises a system information block (SIB) sent by the relay, the SIB including the capacity of the relay.

24. The apparatus of claim 21, wherein the message comprises a measurement report sent by the relay, and wherein the quality of the relay backhaul is determined based on a backhaul-link quality measurement provided in the measurement report.

25. The apparatus of claim 21, wherein the message comprises a message received over an X2 interface from a different eNB serving the relay, and wherein the quality of the relay backhaul is determined based on the message.

26. The apparatus of claim 14, wherein the handover is initiated by an eNB based on a determination of available capacity of the relay inferred from X2 messages.

27. The apparatus of claim 14, wherein the relay rejects a handover of the UE based on available capacity of the relay.

28. An apparatus for wireless communication, comprising:
a processing system configured to:
determine an operational characteristic of a relay, the relay being a user equipment (UE) serving as an eNB, the operational characteristic comprising one or more of a quality of a relay backhaul and a capacity of the relay backhaul, the relay backhaul comprising a communications link between the relay and an eNB; and
determine whether to perform a handover of a UE based on the operational characteristic of the relay and a corresponding operational characteristic of the eNB.

29. A computer program product, comprising:
a computer-readable medium comprising code for:
determining an operational characteristic of a relay, the relay being a user equipment (UE) serving as an eNB, the operational characteristic comprising one or more of a quality of a relay backhaul and a capacity of the relay backhaul, the relay backhaul comprising a communications link between the relay and an eNB; and
determining whether to perform a handover of a UE based on the operational characteristic of the relay and a corresponding operational characteristic of the eNB.

30. A method of wireless communication of a relay, comprising:
receiving a request to handover a user equipment (UE), the request including a measurement report;
determining an operational characteristic of the relay, the operational characteristic of the relay comprising one or more of a quality of a relay backhaul and a capacity of the relay backhaul, the relay backhaul comprising a communications link between the relay and an eNB;
determining one or more operational characteristics of the UE based on the measurement report, the one or more operational characteristics comprising one or more of a quality of a UE access to the eNB; and
accepting the handover when the difference between corresponding operational characteristics of the relay and the eNB exceeds a first threshold value.

31. The method of claim 30, further comprising rejecting the handover when the difference between corresponding operational characteristics of the eNB and the relay is less than a second threshold value.

32. An apparatus for wireless communication, comprising:
means for receiving a request to handover a user equipment (UE), the request including a measurement report;
means for determining an operational characteristic of a relay, the operational characteristic of the relay comprising one or more of a quality of a backhaul relay and a capacity of the relay backhaul, the relay backhaul comprising a communications link between the relay and an eNB;
means for determining one or more operational characteristics of the UE based on the measurement report, the one or more operational characteristics comprising one or more of a quality of a UE access to the eNB; and
means for accepting the handover when the difference between corresponding operational characteristics of the relay and the eNB exceeds a first threshold value, wherein the handover is rejected when the difference between corresponding operational characteristics of the eNB and the relay is less than a second threshold value.

33. An apparatus for wireless communication, comprising:
a processing system configured to:
receive a request to handover a user equipment (UE), the request including a measurement report;
determine an operational characteristic of a relay, the operational characteristic of the relay comprising one or more of a quality of a backhaul relay and a capacity of the relay backhaul, the relay backhaul comprising a communications link between the relay and an eNB;
determine one or more operational characteristics of the UE based on the measurement report, the one or more operational characteristics comprising one or more of a quality of a UE access to the eNB;
accept the handover when the difference between corresponding operational characteristics of the relay and the eNB exceeds a first threshold value; and
reject the handover when the difference between corresponding operational characteristics of the eNB and the relay is less than a second threshold value.

34. A computer program product, comprising:
a computer-readable medium comprising code for:
receiving a request to handover a user equipment (UE), the request including a measurement report;
determining an operational characteristic of a relay, the operational characteristic of the relay comprising one or more of a quality of a backhaul relay and a capacity of the relay backhaul, the relay backhaul comprising a communications link between the relay and an eNB;
determining one or more operational characteristics of the UE based on the measurement report, the one or more operational characteristics comprising one or more of a quality of a UE access to the eNB;
accepting the handover when the difference between corresponding operational characteristics of the relay and the eNB exceeds a first threshold value; and
rejecting the handover when the difference between corresponding operational characteristics of the eNB and the relay is less than a second threshold value.
